(19) United States
(12) Patent Application Publication
(10) Pub. No.: US 2021/0080848 A1
(43) Pub. Date: Mar. 18, 2021

(54) LIQUID DEVELOPER

(71) Applicant: CANON KABUSHIKI KAISHA, Tokyo (JP)

(72) Inventors: Naohiko Tsuchida, Tokyo (JP); Takashi Hirasa, Moriya-shi (JP); Yasutaka Akashi, Yokohama-shi (JP); Masato Nakajima, Moriya-shi (JP); Yuzo Tokunaga, Chiba-shi (JP); Kohji Takenaka, Toride-shi (JP); Akifumi Matsubara, Kashiwa-shi (JP); Yuya Chimoto, Funabashi-shi (JP); Kouichirou Ochi, Chiba-shi (JP); Tomoyo Miyakai, Tokyo (JP)

(21) Appl. No.: 17/012,718

(22) Filed: Sep. 4, 2020

(30) Foreign Application Priority Data
Sep. 13, 2019 (JP) 2019-166767

(51) Int. Cl. G03G 9/13; G03G 9/135

(52) U.S. Cl. CPC G03G 9/132; G03G 9/1355

(57) ABSTRACT

A liquid developer containing: a toner containing a binder resin; a carrier liquid; and a basic toner dispersing agent, wherein the binder resin contains a polylactic acid, the polylactic acid has an acid value of at least 5 mg KOH/g, and a content of the polylactic acid in the binder resin is at least 50 mass %.

### BACKGROUND OF THE INVENTION

### Field of the Invention

The present disclosure relates to a liquid developer used in image-forming methods that employ an electrophotographic system.

### Description of the Related Art

Attention has been directed in recent years to plastics from plant-based starting materials that derive from an atmospheric carbon source (carbon dioxide). Within this sphere, research and development toward the practical use of polylactic acid, which exhibits an excellent biodegradability and is relatively favorable from a cost standpoint, is quite active. The field of high-speed, high-image-quality digital printing using liquid developer-based electrophotographic technology is also no exception here, and Japanese Patent Application Laid-open No. 2014-157188 provides an example of a liquid developer that contains polylactic acid in the binder resin.

### SUMMARY OF THE INVENTION

However, it has been found with regard to liquid developers that contain polylactic acid in the binder resin that, as the polylactic acid content is increased in order to provide a particularly high biodegradability, during long-term storage toner particle aggregation may occur and/or cloudiness may occur due to crystallization of the polylactic acid and the tinge of the printed matter may decline.

There is no precedent that focuses on these problems, and a solution is required as quickly as possible.

The present disclosure provides a liquid developer that has a high biodegradability as well as an excellent dispersibility and tinge even with long-term storage.

A liquid developer comprising:

a toner containing a binder resin;

a carrier liquid; and

a basic toner dispersing agent, wherein

the binder resin contains a polylactic acid,

the polylactic acid has an acid value of at least 5 mg KOH/g, and

a content of the polylactic acid in the binder resin is at least 50 mass %.

According to the present disclosure, a liquid developer that has a high biodegradability as well as an excellent dispersibility and tinge even with long-term storage can be provided.

Further features of the present invention will become apparent from the following description of exemplary embodiments.

### DESCRIPTION OF THE EMBODIMENTS

Unless specifically indicated otherwise, the expressions “from XX to YY” and “XX to YY” that show numerical value ranges refer to numerical value ranges that include the lower limit and upper limit that are the end points.

When numerical value ranges are provided in stages, the upper limits and lower limits of the individual numerical value ranges may be combined in any combination.

The liquid developer is a liquid developer comprising a toner containing a binder resin, a carrier liquid and a basic toner dispersing agent, wherein the binder resin contains a polylactic acid, the polylactic acid has an acid value of at least 5 mg KOH/g, and a content of the polylactic acid in the binder resin is at least 50 mass %.

A liquid developer having a high biodegradability and having an excellent dispersibility and excellent tinge even with long-term storage can be obtained by using the above-mentioned liquid developer.

On the occasion of intensive investigations into a liquid developer that would have a high biodegradability and an excellent dispersibility and excellent tinge even with long-term storage, the present inventors discovered that the use in the binder resin of highly biodegradable polylactic acid, the content and acid value of the polylactic acid, and the toner dispersing agent are crucial. It was specifically determined that the use of a polylactic acid having an acid value of at least 5 mg KOH/g for at least 50 mass % of the binder resin present in the toner, and the use of a basic toner dispersing agent for the toner dispersing agent, are crucial.

In order to impart a high dispersibility to toner that uses polylactic acid with its high biodegradability, the present inventors focused on the interaction between the toner and toner dispersing agent. It was found as a result that, by providing the polylactic acid with an acid value of at least 5 mg KOH/g and by using a toner dispersing agent that has a basic functional group for its adsorptive group, the interaction between the toner and toner dispersing agent is improved and a high dispersibility is imparted to the toner even during long-term storage.

However, as result of continuing investigations, the present inventors discovered an unexpected effect: this toner, while not only exhibiting a high dispersibility during long-term storage, also exhibits excellent properties on a long-term basis with regard to the tinge of the toner.

As to the reason for this, for a toner that for whatever reason uses polylactic acid for its binder resin, there may be a connection to the cloudiness and reduction in toner tinge due to the advance of crystallization of the polylactic acid during long-term storage. Due to this, the present inventors believe that, by providing the polylactic acid with an acid value and providing a basic functional group for the adsorptive group in the toner dispersing agent, the interaction between the two is further strengthened and this is likely linked to an unexpected prevention of crystallization of the polylactic acid.

It is believed that as a result the clouding of the binder resin due to the development of polylactic acid crystallization can be prevented and a liquid developer with an excellent tinge even over long-term storage can be obtained.

As a result of additional intensive investigations, the present inventors found that a highly biodegradable toner that exhibits a high dispersibility and an excellent tinge on a long-term basis is obtained through the use of a basic toner dispersing agent and a polylactic acid having an acid value of at least 5 mg KOH/g for at least 50 mass % of the binder resin present in the toner.

When the polylactic acid content is less than 50 mass % of the binder resin contained in the toner, the biodegradability, which is the initial goal, becomes poor. The polylactic acid content in the binder resin is preferably from 50 mass % to 99 mass %, more preferably from 50 mass % to 90 mass %, and still more preferably from 50 mass % to 85 mass %.

When the acid value of the polylactic acid is less than 5 mg KOH/g, the interaction with the basic dispersing agent may then be weak and the dispersibility during long-term storage may be reduced and the toner may undergo aggregation; also, the tinge of the toner may be reduced due to the development of polylactic acid crystallization.

The acid value of the polylactic acid is preferably from 5 mg KOH/g to 100 mg KOH/g, more preferably from 5 mg KOH/g to 50 mg KOH/g, and still more preferably from 8 mg KOH/g to 30 mg KOH/g.

The following methods are examples of methods for adjusting the acid value of the polylactic acid: adjusting the molecular weight of the polylactic acid, capping the terminal group of the polylactic acid with acid group-bearing multifunctional monomer, and capping the terminal carboxy group on the polylactic acid.

The toner dispersing agent must be a basic toner dispersing agent. The basic toner dispersing agent here refers to a toner dispersing agent that uses for its adsorptive group a functional group that exhibits basicity. The functional group that exhibits basicity can be exemplified by the amino group, nitrogenous heterocyclic groups, oxygenated heterocyclic groups, polar phospholipid groups, and so forth. These functional groups are thought to readily interact with polylactic acid.

The functional group should be basic and is not otherwise particularly limited, but the functional group preferably has an amino group. That is, the dispersibility of the toner is improved when the basic toner dispersing agent is an amino group-containing toner dispersing agent, and this is thus preferred. Moreover, the amine value of the amino group-containing toner dispersing agent is preferably at least 10 mg KOH/g and more preferably at least 20 mg KOH/g. When this range is observed, a strengthening of the interaction between the polylactic acid and amino group-containing toner dispersing agent can be expected, and as a consequence obtaining a toner having an excellent tinge even with long-term storage is facilitated. The amine value of the amino group-containing toner dispersing agent is preferably not more than 100 mg KOH/g and is more preferably not more than 50 mg KOH/g.

The amino group-containing toner dispersing agent preferably contains a polymer that contains both a structure represented by formula (1A) below and a structure represented by formula (2A) below, and more preferably contains a polymer that contains both a structure represented by formula (1) below and a structure represented by formula (2) below. This serves to bring about an additional increase in toner dispersibility. The amino group-containing toner dispersing agent is even more preferably composed of the following formulas (1) and (2).

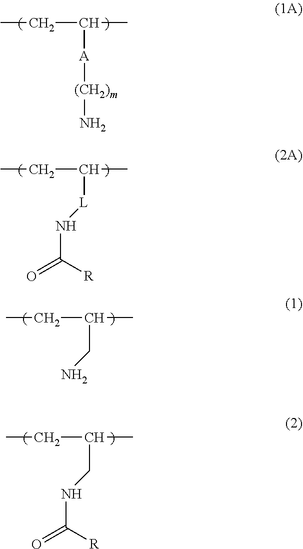

In formula (1A), A represents a single bond, an alkylene group having 1 to 6 carbons (preferably 1 to 3 carbons), or phenylene, and m represents an integer from 0 to 3. In formula (2A), L is preferably an alkylene group having from 1 to 6 carbons (more preferably an alkylene group having from 1 to 3 carbons), an alkenylene group having from 1 to 6 carbons (more preferably an alkenylene group having from 1 to 3 carbons), or an arylene group having from 6 to 10 carbons. The R in formulas (2A) and (2) is an alkyl group having from 6 to 30 (preferably from 12 to 22 and more preferably 16 to 20) carbons.

R may contain branching, but is preferably a straight-chain alkyl group. R may also have a substituent. The substituent on R is not particularly limited and can be exemplified by alkoxy groups, halogen atoms, the amino group, the hydroxyl group, the carboxy group, carboxylate ester groups, and carboxamide groups.

There are no particular limitations on the content ratio in the amino group-containing toner dispersing agent between the structure with formula (1A) and the structure with formula (2A), but (1A):(2A) (preferably (1):(2)) is preferably from 90:10 to 5:95, more preferably from 70:30 to 10:90, and still more preferably from 40:60 to 13:87.

The total content in the amino group-containing toner dispersing agent of the structure with formula (1A) and the structure with formula (2A) (preferably the total content of the structure with formula (1) and the structure with formula (2)) is preferably from 50 mass % to 100 mass %, more preferably from 80 mass % to 100 mass %, and still more preferably from 90 mass % to 100 mass %.

The content of this toner dispersing agent, per 100 mass parts of the binder resin, is preferably from 0.5 mass parts to 30 mass parts and is more preferably from 5 mass parts to 25 mass parts. A single toner dispersing agent may be used or two or more may be used.

The number-average molecular weight of the toner dispersing agent is preferably from 5,000 to 50,000 and is more preferably from 10,000 to 40,000.

The crystallinity of the binder resin is preferably not more than 35% and is more preferably not more than 30%. An excellent tinge is established when this range is observed. The lower limit is not particularly limited, but at least 3% is preferred and at least 8% is more preferred.

The crystallinity can be controlled during resin production through, for example, the polymerization temperature, heat treatment temperature, cooling rate, and so forth.

When, moreover, the total number of acid groups contained in the polylactic acid is larger than the total number of amino groups contained in the amino group-containing toner dispersing agent, the amino group-containing toner dispersing agent added to the liquid developer is then not present in excess and a high potential for interaction with the polylactic acid is established, and this is thus preferred from the standpoint of the dispersing performance.

The ratio of the total number of acid groups contained in the polylactic acid to the total number of amino groups contained in the amino group-containing dispersing agent (acid group/amino group) preferably exceeds 1.0 and is more preferably equal to or greater than 2.0. While the upper limit is not particularly limited, it is preferably not more than 10.0 and more preferably not more than 7.0.

The volume median diameter D50 of the toner in the liquid developer is preferably not greater than 2.0 μm and is more preferably not greater than 1.5 μm. The lower limit is not particularly limited, but at least 0.3 μm is preferred and at least 0.5 μm is more preferred.

Binder Resin

At least 50 mass % of the binder resin should be polylactic acid. The method of producing the polylactic acid is not particularly limited and known methods may be used. A single one of, e.g., L-lactic acid, D-lactic acid, L-lactide, D-lactide, DL-lactide, and so forth, or a mixture of a plurality thereof, may be polymerized.

Another resin may also be used in the binder resin in addition to the polylactic acid.

This additional resin is not particularly limited and can be exemplified by vinyl resins, polyester resins, polyurethane resins, polyester-urethane resins, epoxy resins, polyamide resins, polyimide resins, and polycarbonate resins. Polyester resins are preferred based on a consideration of the compatibility with polylactic acid. Two or more of these resins may be used in combination.

The binder resin preferably contains polyester resin. The polyester resin content in the binder resin is preferably from 1 mass % to 50 mass %, more preferably from 5 mass % to 45 mass %, and still more preferably from 8 mass % to 42 mass %.

A polyester-urethane resin may be used. Polyester-urethane resins that exhibit pigment dispersibility can be exemplified by Vylon UR-4800 (Toyobo Co., Ltd.).

The content of polyester-urethane resin in the binder resin is preferably from 1 mass % to 20 mass % and more preferably from 5 mass % to 15 mass %.

The polyester resin is not particularly limited, and can be exemplified by condensation polymers between an alcohol component and a carboxylic acid component.

This alcohol component can be specifically exemplified by the following:

alkylene oxide adducts on bisphenol A, e.g., polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane, as well as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene, and derivatives of the preceding.

The derivative should provide the same resin structure by the aforementioned condensation polymerization, but is not otherwise particularly limited. An example is a derivative provided by the esterification of the aforementioned alcohol component.

The carboxylic acid component, on the other hand, can be exemplified by the following:

aromatic dicarboxylic acids such as phthalic acid, isophthalic acid, and terephthalic acid and their anhydrides; alkyl dicarboxylic acids such as succinic acid, adipic acid, sebacic acid, and azelaic acid and their anhydrides; succinic acid substituted by an alkyl group or alkenyl group having 6 to 18 carbons, and anhydrides thereof; unsaturated dicarboxylic acids such as fumaric acid, maleic acid, and citraconic acid and their anhydrides; polybasic carboxylic acids, e.g., trimellitic acid, pyromellitic acid, and benzophenonetetracarboxylic acid and anhydrides thereof; and derivatives of the preceding.

The derivative should provide the same resin structure by the aforementioned condensation polymerization, but is not otherwise particularly limited. Examples are derivatives provided by the methyl esterification, ethyl esterification, or conversion to the acid chloride of the aforementioned carboxylic acid component.

The acid value of the polyester resin is preferably from 5 mg KOH/g to 100 mg KOH/g, more preferably from 5 mg KOH/g to 50 mg KOH/g, and still more preferably from 8 mg KOH/g to 35 mg KOH/g.

When the acid value of the binder resin as a whole is from 10 mg KOH/g to 40 mg KOH/g, this facilitates the occurrence of a strong interaction with the basic toner dispersing agent and facilitates providing the toner with a high dispersibility even during long-term storage, and is thus preferred.

Pigment

A pigment may be used in the liquid developer, and there are no particular limitations on the type. Any generally commercially available organic pigment and inorganic pigment can be used, as can a pigment dispersed in, for example, an insoluble resin as a dispersion medium, as well as pigments provided by grafting a resin onto the pigment surface.

The following are specific examples of organic pigments and inorganic pigments that exhibit a yellow color:

C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and C.I. Vat Yellow 1, 3, and 20.

The following are examples of pigments that exhibit a red or magenta color:

C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, and 269; C.I. Pigment Violet 19; and C.I. Vat Red 1, 2, 10, 13, 15, 23, 29, and 35.

The following are examples of pigments that exhibit a blue or cyan color:

C.I. Pigment Blue 2, 3, 15:2, 15:3, 15:4, 16, and 17; C.I. Vat Blue 6; C.I. Acid Blue 45; and copper phthalocyanine pigments in which 1 to 5 phthalimidomethyl groups are substituted on the phthalocyanine skeleton.

The following are examples of pigments that exhibit a green color: C.I. Pigment Green 7, 8, and 36.

The following are examples of pigments that exhibit an orange color: C.I. Pigment Orange 66 and 51.

The following are examples of pigments that exhibit a black color: carbon black, titanium black, and aniline black.

Specific examples of white pigments are as follows: basic lead carbonate, zinc oxide, titanium oxide, and strontium titanate.

Dispersing devices such as, for example, a ball mill, sand mill, attritor, roll mill, jet mill, homogenizer, paint shaker, kneader, agitator, Henschel mixer, colloid mill, ultrasound homogenizer, pearl mill, and wet jet mill, can be used to disperse the pigment.

Carrier Liquid

The carrier liquid present in the liquid developer preferably is nonvolatile at normal temperatures and exhibits electrical insulating behavior, and, for example, low-dielectric constant carrier liquids having a dielectric constant of not more than 3 are advantageous. This is because the electrostatic latent image is normally not disturbed when the carrier liquid has a resistance value in the indicated range. This carrier liquid is also preferably odorless and nontoxic.

Such a carrier liquid can be exemplified by aliphatic hydrocarbons, alicyclic hydrocarbons, aromatic hydrocarbons, halogenated hydrocarbons, polysiloxanes, silicone oils, animal and plant oils, mineral oils, and so forth. In particular, normal-paraffin solvents and isoparaffin solvents are preferred from the standpoints of odor, lack of toxicity, and cost.

Examples at a more specific level are Moresco White P40 (trade name), Moresco White P60 (trade name), and Moresco White P120 (trade name), from MORESCO Corporation; Isopar (trade name, ExxonMobil Chemical); Shellsol 71 (trade name, Shell Petrochemicals Co., Ltd.); and IP Solvent 1620 (trade name, Idemitsu Petrochemical Co., Ltd.) and IP Solvent 2028 (trade name, Idemitsu Petrochemical Co., Ltd.).

An electrically insulating carrier liquid that is nonvolatile at normal temperature, and that at the same time is a curable carrier liquid that does not impart fixability to the toner, may also be used.

In the case of use of a curable carrier liquid, the carrier liquid can be selected from polymerizable liquid monomers. The polymerizable liquid monomer can be exemplified by acrylic monomers, vinyl ether compounds, and cyclic ether monomers such as epoxides and oxetanes.

Charge Control Agent

The liquid developer may as necessary contain a charge control agent. Known charge control agents can be used as this charge control agent.

Specific compounds are, for example, fats and oils such as linseed oil and soybean oil; alkyd resins; halogen polymers; aromatic polycarboxylic acids; acidic group-containing water-soluble dyes; oxidative condensates of aromatic polyamines; metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate; sulfonate metal salts such as metal petroleum sulfonates and metal salts of sulfosuccinate esters; phospholipids such as lecithin; metal salicylate salts such as metal complexes of t-butylsalicylic acid; as well as polyvinylpyrrolidone resins, polyamide resins, sulfonic acid-containing resins, and hydroxybenzoic acid derivatives.

Charge Adjuvant

The toner may contain a charge adjuvant on an optional basis. A known charge adjuvant can be used as this charge adjuvant.

The following are examples of specific compounds: metal soaps such as zirconium naphthenate, cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, aluminum tristearate, and cobalt 2-ethylhexanoate; sulfonate metal salts such as metal petroleum sulfonates and metal salts of sulfosuccinate esters; phospholipids such as lecithin and hydrogenated lecithin; metal salicylate salts such as metal complexes of t-butylsalicylic acid; as well as polyvinylpyrrolidone resins, polyamide resins, sulfonic acid-containing resins, and hydroxybenzoic acid derivatives.

Other Additives

Besides the preceding, suitable selections from various known additives, for example, polymerization inhibitors, surfactants, lubricants, fillers, defoamants, ultraviolet absorbers, oxidation inhibitors, antifading agents, antimolds, rust inhibitors, and so forth, may be used on an optional basis in the liquid developer with the goals of improving the recording medium compatibility, storage stability, image storability, and other properties.

Method of Producing Liquid Developer

The liquid developer production method can be exemplified by a method in which toner produced by, for example, a dry pulverization method or a wet pulverization method is dispersed along with the toner dispersing agent in the carrier liquid.

Another advantageous method of producing the liquid developer is the so-called coacervation method, including:

(1) a pigment dispersion step of preparing a pigment dispersion that contains a binder resin, pigment, basic toner dispersing agent, and solvent;
(2) a mixing step of adding, to the pigment dispersion, a solvent that does not dissolve the binder resin and preparing a mixture; and
(3) a distillative removal step of distilling the solvent from the mixture.

Solvent usable in the pigment dispersion step should be solvent that can dissolve the binder resin, but is not otherwise particularly limited.

Examples here are ethers such as tetrahydrofuran; ketones such as methyl ethyl ketone, cyclohexanone, and acetone; esters such as ethyl acetate; and halides such as chloroform. In addition, the solvent may be an aromatic hydrocarbon, e.g., toluene, benzene, and so forth, when such has the ability to dissolve the resin.

A hydrocarbon organic solvent, e.g., n-hexane, an isoparaffin solvent, and so forth, or a silicone oil can be suitably used as the solvent that does not dissolve the binder resin for use in the mixing step. The developer can be produced by carrying out toner production using such a solvent and carrying out either the addition of, or substitution with, the insulating carrier liquid according to the present disclosure.

Moreover, a solvent that will function as the insulating carrier liquid can also be used in the mixing step as the solvent that does not dissolve the binder resin.

The methods used to measure the various properties are considered in the following.

### Compositional Analysis

The following procedures are used to determine the structure of, e.g., the compounds and so forth.

The ¹H-NMR and ¹³C-NMR spectra are measured using an ECA-400 (400 MHz) from JEOL Ltd.

The measurement is run at 25° C. in a deuterated solvent containing tetramethylsilane as the internal reference substance, and the chemical shift values are given as the ppm shift value (δ value) using 0 for the tetramethylsilane internal reference substance.

Measurement of Acid Value

The acid value is determined using the following method.

The basic procedure is based on JIS K 0070.

1) 0.5 to 2.0 g of the sample is exactly weighed. This mass is designated M (g).

2) The sample is introduced into a 50-mL beaker, 25 mL of tetrahydrofuran/ethanol mixed solvent (2/1) is added, and dissolution is carried out.

3) Titration is performed using a 0.1 mol/L ethanolic KOH solution and a potentiometric titrator. A “COM-2500” Automatic Titrator from Hiranuma Sangyo Co., Ltd. is used.

4) The amount of the KOH solution used at this time is designated S (mL). The blank is measured at the same time, and the amount of KOH used in this case is designated B (mL).

5) The acid value is calculated using the following formula. Here, f refers to the factor for the KOH solution.

$$acid value [ \frac{mg KOH}{g} ] = \frac{( S - B ) \times f \times 5.61}{M}$$

Separation of Polylactic Acid from Liquid Developer

Separation of the toner in the liquid developer, separation of the binder resin in the toner, and separation of the polylactic acid in the binder resin can be carried out using the following procedures.

(1) The liquid developer is subjected to centrifugal separation in order to sediment the toner; the supernatant is discarded.

(2) Hexane is added to the toner and thorough stirring is carried out; centrifugal separation is performed; and the supernatant is discarded. This sequence is carried out three times, following by thorough drying.

(3) The dried toner is dissolved in deuterochloroform and compositional analysis of the components constituting the toner particle is performed using a JNM-ECA (¹H-NMR) Fourier-transform nuclear magnetic resonance instrument from JEOL Ltd.

(4) Otherwise, tetrahydrofuran is added to the dried toner obtained in (2) above followed by standing overnight. After then thoroughly stirring this, centrifugal separation is carried out and the tetrahydrofuran-insoluble matter is removed. The tetrahydrofuran-soluble component of the supernatant is dried.

(5) The obtained tetrahydrofuran-soluble component is dissolved in tetrahydrofuran. The number-average molecular weight (Mn) of the individual components is determined using gel permeation chromatography (GPC). As necessary, the compositional analysis according to procedure (3) is performed again and identification of the resin and determination of its number-average molecular weight are carried out.

(6) Based on the compositional information and number-average molecular weight for the polylactic acid as obtained in procedures (1) to (5), the polylactic acid is separated using liquid chromatography or GPC.

Measurement of Amine Value

The amine value of the basic toner dispersing agent is determined using the following method.

The basic procedure is based on ASTM D 2074.

1) 0.5 to 2.0 g of the sample is exactly weighed. This mass is designated M (g).

2) The sample is introduced into a 50-mL beaker, 25 mL of tetrahydrofuran/ethanol mixed solvent (3/1) is added, and dissolution is carried out.

3) Titration is performed using a 0.1 mol/L ethanolic HCl solution and a potentiometric titrator. A “COM-2500” Automatic Titrator from Hiranuma Sangyo Co., Ltd. is used.

4) The amount of the HCl solution used here is designated S (mL). The blank is measured at the same time, and the amount of HCl used in this case is designated B (mL).

5) The amine value is calculated using the following formula. Here, f is the factor for the HCl solution.

$$amine value [ \frac{mg KOH}{g} ] = \frac{( S - B ) \times f \times 5.61}{M}$$

Separation of Basic Toner Dispersing Agent from Liquid Developer

The basic toner dispersing agent can be separated from the liquid developer using the same procedure as described above under “Separation of Polylactic Acid from Liquid Developer”. The amine value can be measured using the obtained basic toner dispersing agent.

Measurement of Degree of Crystallinity

The degree of crystallinity is measured using a “Rigaku RINT 2500VC X-ray Diffractometer” (Rigaku Corporation), an instrument for powder x-ray diffraction (XRD) measurements. The powdered sample is measured using x-ray source: Cu/Kα radiation, tube voltage: 40 kV, tube current: 120 mA, measurement range: diffraction angle (2θ) of 5° to 40°, and scanning rate: 5.0°/minute. The degree of crystallinity of the polylactic acid is the value calculated from the obtained x-ray diffraction using the formula given below.

Measurement of Degree of Crystallinity of Binder Resin Contained in Toner in Liquid Developer

The toner is separated from the liquid developer using procedures (1) and (2) described above under “Separation of Polylactic Acid from Liquid Developer”.

The crystalline resin component is isolated from the resin contained in the toner and its degree of crystallinity is measured using the method described above. The crystalline resin component can be isolated, for example, by a procedure in which the toner is subjected to Soxhlet extraction using toluene for the solvent and the crystalline resin component is isolated as the residue. Measurement of the NMR spectrum can be used to confirm that the molecular structure of this extraction residue is crystalline resin.

$$degree of crystallinity ⌈ \% ⌉ = \frac{integration value of the diffraction peak intensity of crystalline origin}{integration value of the peak intensity for overall diffraction} \times 100$$

Volume Median Diameter D50 of Toner

For the volume median diameter D50 of the toner, the 50% particle diameter on a volume basis (D50) is obtained by measurement in the corresponding carrier liquid using a dynamic light-scattering (DLS) particle size distribution analyzer (trade name: Nanotrac 150, MicrotracBEL Corporation).

Measurement of Polylactic Acid Content in Binder Resin in Liquid Developer

The polylactic acid content in the binder resin can be measured by separating, in accordance with the procedures described above in “Separation of Polylactic Acid from Liquid Developer”, the toner from the liquid developer, the binder resin, which is the tetrahydrofuran-soluble component, and the polylactic acid in the binder resin.

Measurement of Ratio between Total Number of Acid Groups Contained in Polylactic Acid in Liquid Developer and Total Number of Amino Groups Contained in Amino Group-containing Toner Dispersing Agent in Liquid Developer

The polylactic acid and amino group-containing toner dispersing agent are separated using the procedures described above in “Separation of Polylactic Acid from Liquid Developer” and “Separation of Basic Toner Dispersing Agent from Liquid Developer”, respectively.

The acid value of the polylactic acid and the amine value of the amino group-containing toner dispersing agent are determined using the procedures described above in “Measurement of Acid Value” and “Measurement of Amine Value”. The total number of acid groups/total number of amino groups is calculated using the following formula.

total number of acid groups/total number of amino groups=(acid value (mg KOH/g)×content (g) of the polylactic acid)/(amine value (mg KOH/g)×content (g) of the amino group-containing toner dispersing agent)

### EXAMPLES

The present disclosure is described in additional detail in the following using examples and comparative examples, but the embodiments of the present disclosure are not limited to or by these. Unless specifically indicated otherwise, the number of parts and % in the examples and comparative examples are on a mass basis in all instances.

Binder Resin Production Example

### Polylactic Acid 1

90.0 parts of L-lactide, 10.0 parts of D-lactide, and 8.0 parts of polyglycerol were introduced into a flask, and the interior temperature was gradually raised and a dehydration treatment was carried out under reduced pressure conditions. 0.03 parts of tin 2-ethylhexanoate was introduced into the system and a polymerization reaction was run.

Distillation at normal pressure was subsequently carried out while raising the liquid temperature to 170° C., and, once a liquid temperature of 170° C. had been achieved, solvent removal was performed by distillation for 1 hour under a reduced pressure of 1 hPa. After the distillation of unreacted material had been completed, 5.0 parts of trimellitic anhydride was introduced; stirring was performed for 2 hours at 180° C.; and the contents were then removed and cooled to yield polylactic acid 1.

The acid value, weight-average molecular weight Mw, degree of crystallinity, and so forth of the obtained polylactic acid 1 are given in Table 1.

Polylactic Acids 2 to 4

Polylactic acids 2 to 4 were obtained by changing the amounts of addition of various materials from those for polylactic acid 1. Several properties are shown in Table 1.

The changes in the amounts of addition were as follows:

polylactic acid 2: 2.5 parts was used for the trimellitic anhydride; polylactic acid 3: 1.5 parts was used for the trimellitic anhydride and 0.04 parts was used for the tin 2-ethylhexanoate; and polylactic acid 4: 1.0 parts was used for the trimellitic anhydride and 0.05 parts was used for the tin 2-ethylhexanoate.

Polyester Resins 1 and 2

Polyester resins 1 and 2 were obtained by the same method as in the polylactic acid 1 production example, but changing to the following polyester resin monomers in the polylactic acid 1 production example. Several properties are shown in Table 1.

polyester resin 1: monomer (terephthalic acid: trimellitic anhydride: 2 mol ethylene oxide adduct on bisphenol A), composition (molar ratio=35:15:50)
polyester resin 2: monomer (terephthalic acid: trimellitic anhydride: 2 mol ethylene oxide adduct on bisphenol A), composition (molar ratio=45:5:50)

Basic Toner Dispersing Agent Production Example Basic Toner Dispersing Agent 1

The following production method was used to produce an amino group-containing basic toner dispersing agent having the structure indicated below. The “x/y” in the formula indicates the mass ratio, and amino group-containing basic toner dispersing agent 1 has x:y=15:85.

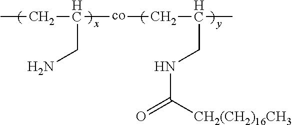

First, while carrying out nitrogen substitution, 100 parts of propylene glycol monomethyl ether was heated under reflux at a liquid temperature of at least 120° C., and into this was added dropwise over 3 hours a mixture of 15 parts of monomer (a-1) and 85 parts of monomer (a-2), as shown by the structures given below, with 1.0 parts of tert-butyl peroxybenzoate [organoperoxide-type polymerization initiator, trade name: Perbutyl Z, NOF Corporation].

The solution was stirred for 3 hours after the completion of the dropwise addition, followed by distillation at normal pressure while raising the liquid temperature to 170° C. Once a liquid temperature of 170° C. had been reached, solvent removal was performed by distillation for 1 hour under a reduced pressure of 1 hPa to yield the basic toner dispersing agent 1. The amine value of the obtained basic toner dispersing agent 1 was 40 mg KOH/g.

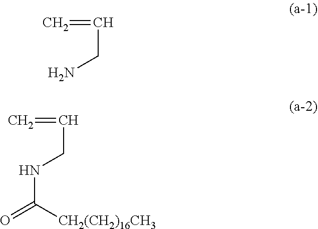

Basic Toner Dispersing Agents 2 and 3

Basic toner dispersing agents 2 and 3 were obtained by the same method as in the production example for basic toner dispersing agent 1, but changing the monomer ratios.

The monomer ratios are as follows.

basic toner dispersing agent 2 (x:y=12:88)
basic toner dispersing agent 3 (x:y=10:90)

Basic Toner Dispersing Agent 4

Solsperse 13940 from the Lubrizol Corporation was used as the basic toner dispersing agent 4.

Acidic Toner Dispersing Agent 1

Solsperse 3000 from the Lubrizol Corporation was used as the acidic toner dispersing agent 1.

The amine value and presence/absence of the amino group are indicated in Table 2 for the toner dispersing agents that were used.

### Example 1

### Liquid Developer Production

### Pigment Dispersion Production Step

### Pigment Dispersion 1 Production Example

Pigment Blue 15:3 (34 parts), 34 parts of Vylon UR-4800 (32% resin concentration, Toyobo Co., Ltd.), 255 parts of tetrahydrofuran, and 130 parts of glass beads (1 mmϕ) were mixed; dispersion was performed for 3 hours using an attritor [Nippon Coke & Engineering Co., Ltd.]; and filtration across a mesh was carried out to obtain a mixture.

180 parts of the mixture prepared as described above, 120 parts of a 50 mass % tetrahydrofuran solution of 24 parts of polyester resin 1 mixed with 30 parts of polylactic acid 1, and 21 parts of the basic toner dispersing agent 1 were mixed; mixing was carried out with a high-speed disperser (T.K. Robomix/T.K. Homodisper Model 2.5 impeller, PRIMIX Corporation); and mixing while stirring at 40° C. yielded a pigment dispersion 1.

Mixing Step

### Mixture 1 Production Example

A mixture 1 was obtained by adding 100 parts of Moresco White P-40 (MORESCO Corporation) in small portions to 100 parts of the pigment dispersion 1 obtained as described above, while stirring at high speed (25,000 rpm) using a homogenizer (Ultra-Turrax T50, IKA).

Distillative Removal Step

The resulting mixture 1 was transferred to a recovery flask and the tetrahydrofuran was completely distilled off at 50° C. while performing ultrasound dispersion to obtain a toner dispersion 1.

Liquid Developer Preparation Step

### Liquid Developer 1 Production Example

10 parts of the obtained toner dispersion 1 was subjected to a centrifugal separation process; the supernatant was removed by decantation; replacement was carried out using fresh Moresco White P-40 in the same mass as the supernatant that had been removed; and redispersion was carried out. This was followed by the addition of 0.10 parts of hydrogenated lecithin (Lecinol S-10, Nikko Chemicals Co., Ltd.) as charge control agent and 80 parts of Moresco White P-40 as carrier liquid to obtain a liquid developer 1 having a volume median diameter D50 for the toner of 0.7 μm.

Liquid Developers 2 to 10 Production Example

Liquid developers 2 to 10 were obtained proceeding as for the liquid developer 1, but changing the type and amount of the resin and toner dispersing agent in the Liquid Developer 1 Production Example to the conditions described in Table 3.

The obtained liquid developers 1 to 10 were evaluated using the following methods. The results of the evaluations are given in Table 4.

Biodegradability

Centrifugal separation was carried out on 10 g of the obtained liquid developer and the supernatant was removed. This was followed by washing with hexane and then drying at normal temperature using a vacuum dryer to obtain the toner. The obtained toner was molded into a film (thickness=15 μm) using an inflation molder, and the molded film was cut to a size of 5 cm×20 cm and this was buried in soil. After 6 months, the percentage mass loss of the film was measured in order to evaluate whether biodegradability was present.

Biodegradability was scored as being present when the progression of biodegradation over a 6-month time period was at least 60 mass %, which can generally be regarded as indicating the presence of biodegradability. The results for liquid developers 1 to 10 are given in Table 4.

Dispersion Stability

The liquid developer was stored for 3 months at 30° C. and 80% RH. The particle diameter of the toner was measured before and after storage as the 50% particle diameter on a volume basis (D50) using a dynamic light-scattering (DLS) particle size distribution analyzer (trade name: Nanotrac 150, MicrotracBEL Corporation). The dispersion stability of the toner was evaluated, as the ratio of the toner particle diameter post-versus-pre-storage (D50 diameter post-storage/D50 diameter pre-storage), using the following criteria.

A: the toner particle diameter ratio is equal to or greater than 1.00 and less than 1.05 (very good)
B: the toner particle diameter ratio is equal to or greater than 1.05 and less than 1.10 (good)
C: the toner particle diameter ratio is equal to or greater than 1.10 and less than 1.20 (the effects according to the disclosure were seen)
D: the toner particle diameter ratio is equal to or greater than 1.20 and less than 1.40 (the effects according to the disclosure were seen to a slight degree)
E: the toner particle diameter ratio is equal to or greater than 1.40 (the effects according to the disclosure were not seen)

Tinge

Using various bar coaters, the liquid developer was formed into a film with an area of at least 50 mm×50 mm on OK Top Coat 157 (Oji Paper Co., Ltd.) with the amount of toner being changed in steps in the range from 0.1 to 1.0 mg/cm′.

This was introduced into a machine provided by modifying an imagePress C800 full-color copier from Canon, Inc. so as to enable the fixation temperature and process speed to be freely set, and a fixing process was carried out using a preheating temperature of 60° C., a fixing roller surface temperature of 140° C., a fixing roller pressure of 100 kgf/cm², and a fixing speed of 150 mm/s.

The L* and c* (chroma) of the resulting image was measured using a SpectroScan Transmission (GretagMacbeth), and the evaluation was carried out using the value of c* when L*=80 on the L*-c* coordinate axes.

A: c* is equal to or greater than 29 (very good)
B: c* is equal to or greater than 27 and less than 29 (good)
C: c* is equal to or greater than 25 and less than 27 (the effects according to the disclosure were seen to a slight degree)
D: c* is less than 25 (the effects according to the disclosure were not seen)

TABLE 1

| | | | weight-average |
|---|---|---|---|
| | acid value/ | degree of | molecular weight |
| binder resin | mgKOH/g | crystallinity/% | Mw |
| polylactic acid 1 | 20 | 20 | 20000 |
| polylactic acid 2 | 10 | 40 | 15000 |
| polylactic acid 3 | 5 | 40 | 17000 |
| polylactic acid 4 | 3 | 40 | 20000 |
| polyester resin 1 | 30 | 0 | 16000 |
| polyester resin 2 | 10 | 0 | 18000 |

TABLE 2

| | presence/absence | |
|---|---|---|
| toner dispersing agent | of amino group | amine value |
| basic toner dispersing agent 1 | present | 40 |
| basic toner dispersing agent 2 | present | 20 |
| basic toner dispersing agent 3 | present | 15 |
| basic toner dispersing agent 4 | absent | — |
| acidic toner dispersing agent 1 | absent | — |

The unit for the amine value in the table is mg KOH/g.

TABLE 3

| | binder resin | | | | | | | | |
|---|---|---|---|---|---|---|---|---|---|
| | | | | | pigment | | polylactic | overall binder resin | |
| | | | | | dispersing | | acid | degree of | |
| liquid developer No. | type | % | type | % | resin | % | content/% | crystallinity | acid value |
| liquid developer 1 | polylactic acid 1 | 50 | polyester resin 1 | 40 | UR4800 | 10 | 50 | 10 | 25 |
| liquid developer 2 | polylactic acid 2 | 80 | polyester resin 2 | 10 | UR4800 | 10 | 80 | 30 | 10 |
| liquid developer 3 | polylactic acid 2 | 90 | — | — | UR4800 | 10 | 90 | 40 | 10 |
| liquid developer 4 | polylactic acid 3 | 90 | — | — | UR4800 | 10 | 90 | 40 | 5 |
| liquid developer 5 | polylactic acid 3 | 90 | — | — | UR4800 | 10 | 90 | 40 | 5 |
| liquid developer 6 | polylactic acid 3 | 90 | — | — | UR4800 | 10 | 90 | 40 | 5 |
| liquid developer 7 | polylactic acid 3 | 90 | — | — | UR4800 | 10 | 90 | 40 | 5 |
| liquid developer 8 | polylactic acid 4 | 90 | — | — | UR4800 | 10 | 90 | 40 | 3 |
| liquid developer 9 | polylactic acid 2 | 90 | — | — | UR4800 | 10 | 90 | 40 | 10 |
| liquid developer 10 | polylactic acid 2 | 45 | polyester resin 2 | 45 | UR4800 | 10 | 45 | 20 | 10 |

| | toner dispersing agent | | | | toner |
|---|---|---|---|---|---|
| | | amine | | acid group/ | D50 |
| liquid developer No. | type | value | parts | amino group | μm |
| liquid developer 1 | basic toner dispersing agent 1 | 40 | 10 | 6.3 | 0.7 |
| liquid developer 2 | basic toner dispersing agent 2 | 20 | 20 | 2.5 | 1.0 |
| liquid developer 3 | basic toner dispersing agent 2 | 20 | 20 | 2.5 | 1.0 |
| liquid developer 4 | basic toner dispersing agent 2 | 20 | 5 | 5.0 | 2.0 |
| liquid developer 5 | basic toner dispersing agent 3 | 15 | 30 | 1.1 | 1.5 |
| liquid developer 6 | basic toner dispersing agent 3 | 15 | 37 | 0.9 | 0.5 |
| liquid developer 7 | basic toner dispersing agent 4 | — | 10 | — | 1.0 |
| liquid developer 8 | basic toner dispersing agent 1 | 40 | 10 | 0.8 | 2.5 |
| liquid developer 9 | acidic toner dispersing agent 1 | — | 10 | — | 1.5 |
| liquid developer 10 | basic toner dispersing agent 1 | 40 | 10 | 2.5 | 0.7 |

In the table, the % for the binder resin and the polylactic acid content denote mass % in the binder resin. The number of parts of the toner dispersing agent is the number of parts per 100 parts of the binder resin. The unit for the acid value and amine value is mg KOH/g.

TABLE 4

| | | | dispersion | |
|---|---|---|---|---|
| Example No. | liquid developer No. | biodegradability | stability | tinge |
| Example 1 | liquid developer 1 | present | A | A |
| Example 2 | liquid developer 2 | present | A | A |
| Example 3 | liquid developer 3 | present | A | B |
| Example 4 | liquid developer 4 | present | B | B |
| Example 5 | liquid developer 5 | present | B | C |
| Example 6 | liquid developer 6 | present | C | C |
| Example 7 | liquid developer 7 | present | D | C |
| Comparative | liquid developer 8 | present | E | D |
| Example 1 | | | | |
| Comparative | liquid developer 9 | present | E | D |
| Example 2 | | | | |
| Comparative | liquid developer 10 | absent | E | D |
| Example 3 | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-166767, filed Sep. 13, 2019 which is hereby incorporated by reference herein in its entirety.

What is claimed is:

1. A liquid developer comprising:
a toner containing a binder resin;
a carrier liquid; and
a basic toner dispersing agent, wherein
the binder resin contains a polylactic acid,
the polylactic acid has an acid value of at least 5 mg KOH/g, and
a content of the polylactic acid in the binder resin is at least 50 mass %.

2. The liquid developer according to claim 1, wherein the basic toner dispersing agent is an amino group-containing toner dispersing agent.

3. The liquid developer according to claim 2, wherein a total number of acid groups contained in the polylactic acid is larger than a total number of amino groups contained in the amino group-containing toner dispersing agent.

4. The liquid developer according to claim 3, wherein the amino group-containing toner dispersing agent has an amine value of at least 20 mg KOH/g.

5. The liquid developer according to claim 4, wherein the amino group-containing toner dispersing agent contains a polymer that contains both a structure represented by formula (1A) below and a structure represented by formula (2A) below, or contains a polymer that contains both a structure represented by formula (1) below and a structure represented by formula (2) below: 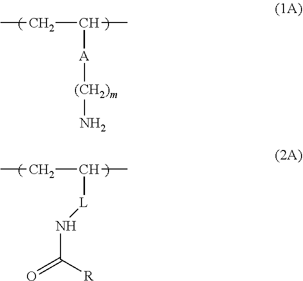
where A represents a single bond, an alkylene group having from 1 to 6 carbons, or phenylene, and m represents an integer from 0 to 3, and L is an alkylene group having from 1 to 6 carbons, an alkenylene group having from 1 to 6 carbons, or an arylene group having from 6 to 10 carbons, and R is an alkyl group having from 6 to 30 carbons, and 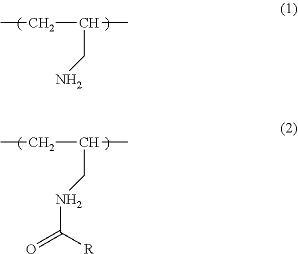
where R is an alkyl group having from 6 to 30 carbons.

6. The liquid developer according to claim 5, wherein the binder resin has a degree of crystallinity of not more than 35%.

7. The liquid developer according to claim 6, wherein the binder resin comprises a polyester resin and a content of the polyester resin in the binder resin is from 1 mass % to 50 mass %.
